(19) United States
(12) Patent Application Publication
(10) Pub. No.: US 2007/0294877 A1
(43) Pub. Date: Dec. 27, 2007

(54) Method for the Production of a Planar Commutator and Conductor Blank for a Planar Commutator

(76) Inventors: Jose Potocnik, Idrija (SI); Boris Kogej, Idrija (SI)

Correspondence Address: KATTEN MUCHIN ROSENMAN LLP, 575 MADISON AVENUE, NEW YORK, NY, 10022-2585, US

(21) Appl. No.: 11/632,560

(22) PCT Filed: Jun. 30, 2005
(86) PCT No.: PCT/EP05/07084

§ 371 Date: Jan. 16, 2007

(30) Foreign Application Priority Data
Jul. 16, 2004 (DE) 10 2004 034 434.5

(51) Int. Cl. H01R 43/06

(52) U.S. Cl. 29/597; 428/542.8

(57) ABSTRACT

The invention relates to the production of a planar commutator with a carbon running surface, wherein an annular closed corrugated conductor blank (1), comprising conductor segments (3) and bridging parts (4) connecting said bridging segments to each other, is produced by rolling from a longitudinal-stepped profiled strip section which is stamped on the edges thereof in order to create contact studs (7) and connection hooks (6). After the band section has been rolled, the contact studs (7) of the conductor segments are bent inwards in the direction of the axis (2) and are profiled on both axial front surfaces by means of a shearing process. The conductor blank is assembled with an annular carbon disk to form a composite part onto which a support element is molded by injection. The annular carbon disk is then subdivided into individual carbon segments and the bridging parts are removed or severed.

The present invention relates to a method for production of a flat commutator, which is provided with a support member made from a molding compound, a plurality of conductor segments anchored in the support member and disposed uniformly around an axis, and an equally large number of carbon segments connected in electrically conductive manner thereto and defining the brush running surfaces, with the following steps:
providing an annularly closed conductor blank with conductor segments and with bridging parts connecting each two adjacent conductor segments with one another, the conductor segments having terminal regions that are aligned substantially axially, each with a terminal hook and contact tabs that are aligned substantially radially;
providing an annular carbon disk;
joining the annular carbon disk and the conductor blank together as a composite part while establishing electrically conductive connections between the contact tabs of the conductor segments and the annular carbon disk;
loading the composite part into an open injection-molding die;
closing the injection-molding die;
molding the support member by injecting plasticized molding compound into the injection-molding die;
removing the commutator blank from the injection-molding die;
dividing the annular carbon disk into individual segments and removing or severing the bridging parts.

Such a method is used, for example, to produce the flat commutators known from German Patent 19956844 A1 and German Patent 19752626 A1. A flat commutator with carbon running surface is also produced by the method of the class in question according to pending German Patent 10359473.6. In that document, the conductor blank is prepared by extrusion forming of a disk punched out of metal sheet (especially copper sheet), the subsequent contact tabs of the conductor segments originating from the center of the disk, the subsequent terminal hooks from the peripheral portion of the disk and the subsequent terminal regions of the conductor segments from the intervening annular region.

Such conductor blanks prefabricated by extrusion forming are also used in the production of flat commutators with carbon running surfaces by other methods, wherein, for example, the bridging parts are already removed before injection molding of the support member, but after the conductor blank has first been joined together with the annular carbon disk as a composite part (see German Patent 4028420 A1), or the annular carbon disk is first applied on the conductor segments that have already been separated from one another, after the support member has first been injection-molded onto the conductor blank and the bridging parts have then been removed (see International Patent WO 97/03486 A1).

Especially the flat commutators produced by application of the method of the class in question according to German Patent 19956844 A1 satisfy stringent requirements. Against the background of general cost pressure, however, it is desired to be able to manufacture a flat commutator having the same favorable characteristics (long useful life and high reliability) as that exhibited by that flat commutator, but for low manufacturing costs.

This objective is achieved according to the present invention by the fact that, in a method of the class in question for production of a flat commutator, prefabrication of the conductor blank is characterized by the following features:
provision of a metal strip having longitudinal tiers, which strip is bounded by a first periphery and a second periphery parallel thereto, wherein the strip has a main portion, which is bounded by a first tier disposed on a first side of the strip adjacent to the first periphery and by a second tier disposed on the other, second side of the strip adjacent to the second periphery, a first peripheral portion disposed between the first periphery and the first tier and a second peripheral portion disposed between the second periphery and the second tier, and the material thickness of the strip at each of the first and second tiers decreases from the main portion to the corresponding peripheral portion, and wherein the strip is further provided on its first side in the region of the second peripheral portion with a third tier, at which the material thickness increases in the direction of the second periphery;
cutting to length of a metal strip portion and punching of the two peripheral portions out of the strip to form the terminal hooks in the first peripheral portion and the contact tabs in the second peripheral portion;
rolling of the strip portion to form a closed annular structure and introduction of undulation in the main portion with undulations jutting out in the region of the bridging parts, wherein the annular structure in the region of the undulations has substantially the same wall thickness as between the undulations;
bending of the contact tabs inward toward the axis;
profiling of the contact tabs on both axial end faces by a shearing process in axial direction.

During application of a method characterized by the combination of these features, flat commutators with carbon running surfaces can be produced at costs below those incurred during the production of flat commutators with substantially identical characteristics according to the prior art. In this connection, two influencing factors in particular come into play. Firstly, the degree of utilization of the starting material is greater during application of the inventive method than according to the prior art; the resulting reduction in cuttings has a commensurate reduction in costs. Furthermore, the inventive method is possible without any extrusion forming, because starting material in the form of strip profiled in the form of longitudinal tiers is used for production of the conductor blank, because the wall thickness of the bridging parts is the same as the wall thickness of the terminal regions of the conductor segments, and because the contact tabs are profiled merely by axial shearing at their axial end faces, thus ensuring that they are optimally connected to the carbon segments and joined with the support member. By the fact that extrusion forming can be completely dispensed with, the technical complexity for performing the inventive method is correspondingly reduced; thus, by application of the present invention, it is possible in particular to dispense completely with soft annealing of the material during the production process. Incidentally, the resulting greater wall thickness of the bridging parts compared with the prior art proves to be favorable for the axial load-bearing capacity thereof, and so the injection-molding die used for injection molding of the support member can itself be operated with correspondingly high closing forces without the danger of damaging the conductor blanks loaded therein, provided the sealing faces present between each two mutually adjacent bridging parts are relatively narrow. One factor in this connection is that, for sealing the injection-molding die against the conductor blank on the side opposite the contact tabs in the region of the axially aligned terminal hooks, (only) the first tier is available, and so the major percentage of the closing force can be carried away via the bridging parts.

As regards the profiling of the contact tabs that is important for the present invention, after they have been bent into their position, which is aligned substantially radially inwardly, by purely axial shearing in upper and lower dies corresponding to one another, pending German Patent Application 10359473.6 of the Applicant filing the present patent application is herewith made subject matter of the disclosure of the present application by reference. The third tier provided according to the present invention on the first side of the strip in the second peripheral portion has the effect that the contact tabs have a greater wall thickness at one end than at transition regions via which they are connected to the terminal regions. This is advantageous for long-lasting connection of the carbon segments to the contact regions of the conductor segments; and the greater material thickness at the ends makes it possible to introduce distinct profiling therein by means of the already explained shearing.

According to a first preferred improvement of the inventive method, it is provided that the bridging parts be completely removed in a single operation by turning them off on a lathe. This is made possible by the fact that the terminal hooks of the commutator blank are aligned in axial direction, so that they do not cause interference while the bridging parts are being turned off. In the prior art, however, because the terminal hooks are radially aligned from the outset, it is not possible to turn off the bridging parts in a single operation.

Concerning the sequence of cutting the metal strip portion to length on the one hand and punching out of the two peripheral strip portions on the other hand, the invention permits several possibilities. According to a first alternative method, the metal strip portion is first cut to length from stock, before the two peripheral metal strip portions are punched out to form the terminal hooks in the first peripheral portion and the contact tabs in the second peripheral portion. According to a second alternative method, it is provided that the metal strip portion is cut to length after the two peripheral metal strip portions have first been punched out to form the terminal hooks in the first peripheral portion and the contact tabs in the second peripheral portion. According to a third alternative method, the metal strip portion is cut to length and, at the same time, and all in the same working step, the two peripheral metal strip portions are punched out to form the terminal hooks and the contact tabs.

The invention also offers several possibilities as regards the sequence of rolling of the strip portion and introduction of undulation. According to a first alternative method in this respect, the strip portion is first rolled to form a closed annular structure, before the undulation is then introduced in the strip portion; in this case, in order to introduce the undulation in the strip portion that has already been annularly closed, it is braced radially on the inside, especially in the region of the bridging portions, while the conductor segments are pushed radially inward by corresponding radial plungers, until they bear on a correspondingly profiled internal die. According to a second alternative method in this respect, it is provided that the strip portion is rolled to form a closed annular structure after the undulation has first been introduced in the strip portion, especially in a stamping press. Here also, a third alternative method is conceivable, wherein the strip portion is rolled to form a closed annular structure and simultaneously the undulation is introduced in a single working step after the contour has first been punched out. In all alternatives, slight deformation of the regions between the undulations, or in other words the initially plane terminal regions of the conductor segments, is preferably also applied during introduction of the undulation, so that these regions are slightly convex; this contributes to minimizing the necessary finish machining of the commutator blank by metal-cutting methods.

According to another preferred improvement of the inventive method, it is provided that the contact tabs are bent inward toward the axis in two steps, the second step being a sizing step. This is favorable in view of the fact that the conductor blank is to be manufactured with particularly small tolerances, in order that it can be joined together with the annular carbon disk while at the same time forming connections that reliably conduct electricity. In particular, this is valid in the case of interlocking engagement of the profiled contact tabs of the conductor segments in correspondingly profiled seats of the annular carbon disk.

Within the scope of the invention, anchoring parts, such as are to be disposed on the radial inside of the conductor segments so that they will become embedded in the molding compound during injection of the support member and anchor the conductor segments therein, are preferably formed by axial slitting of the radial inside faces of the terminal regions of the conductor segments. Preferably two anchoring parts per conductor segment are slit away from the respective terminal region, specifically after introduction of the undulation.

According to yet another preferred improvement of the invention, the punched-out part of the contact tabs extends exclusively in the second peripheral strip portion. In this case, the second tier is available to the conductor blank as a circumferentially closed area comprising a sealing face for sealing of the injection-molding die.

On the opposite side, however, namely in the region of the terminal hooks, the punched-out part preferably extends from the first periphery beyond the first tier into the main strip portion. In this case the corresponding punched-out part of the terminal hooks in the region of the main portion is bounded particularly preferably by conical edges, on which the injection-molding die bears sealingly.

From the foregoing explanations of the inventive method, it can be deduced that a particularly preferred, usable, annularly closed conductor blank for use in a method for production of a flat commutator comprises a plurality of conductor segments disposed uniformly around an axis together with bridging parts connecting each two adjacent conductor segments with one another, the conductor segments having terminal regions that are aligned substantially axially, each with a terminal hook and contact tabs that are aligned substantially radially inwardly, the conductor blank being produced from a metal strip having longitudinal tiers and a butt joint being present in the region of one of the bridging parts, while the bridging parts are made in the form of undulations, which jut outward relative to the conductor segments and have substantially the same wall thickness as the conductor segments. Obviously it is not merely in the method explained in the foregoing that such a conductor blank can be used advantageously. To the contrary, it can also be employed with corresponding advantages in modified methods with a modified sequence of production steps.

According to a preferred improvement of the present invention, the surface of the conductor blank is silvered or tinned in order to improve the electrical contact between the conductor segments and the carbon segments, either in its entirety or at least in regions of the contact tabs scheduled for contact with the carbon segments that will subsequently be derived from the annular carbon disk.

Within the scope of the present invention, it is obviously possible, for production of a plurality of identical conductor blanks, to use a metal strip material preprofiled in the form of longitudinal tiers and having a width corresponding substantially to a multiple of the width of the metal strip necessary to produce a single conductor blank. For this purpose, each two mutually adjacent cut sections in the region of the subsequent terminal hooks can even be fit snugly into one another, thus further increasing the degree of material utilization. To this extent, what is to be understood by the term “periphery” in the scope of the present application is that it defines a physical periphery of the ribbon-like strip only in the case in which there is used as starting material a flat metal strip material with such a width that several neighboring strip portions cannot be punched out. If the latter is the case, however, the term “periphery” indicates an imaginary boundary of the cut-out part in question from the starting material used to produce the respective strip portion.

The present invention will be explained in more detail hereinafter on the basis of a practical example illustrated in the drawing, wherein

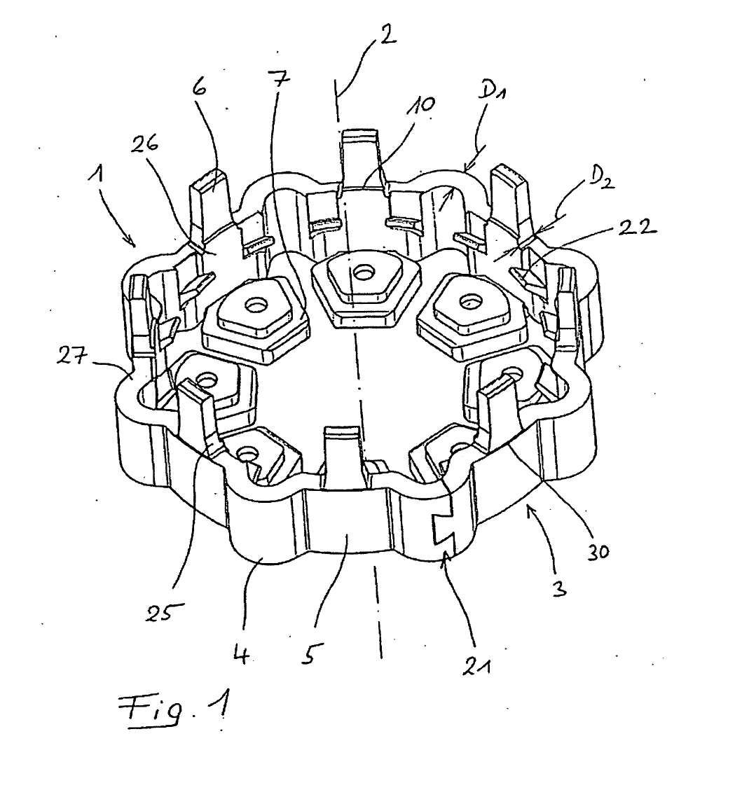

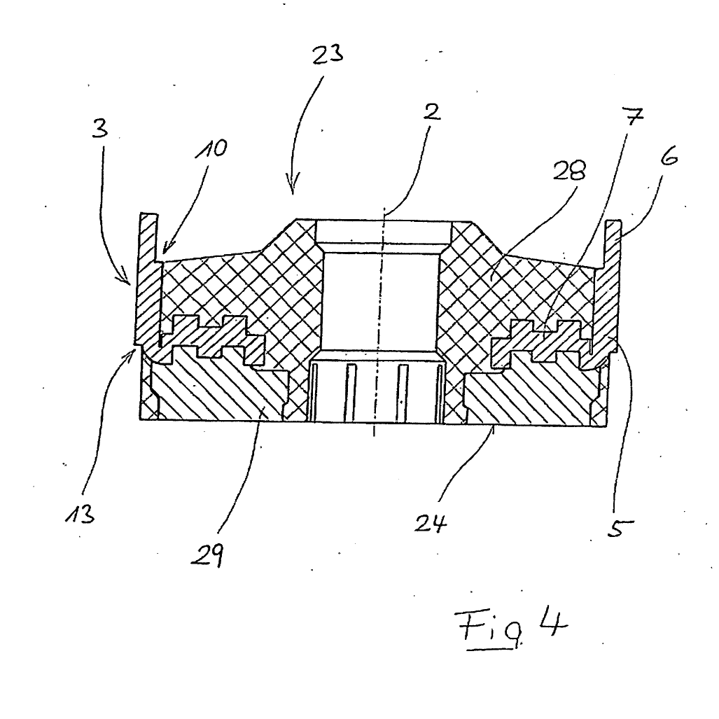

FIG. 1 shows a perspective view of a conductor blank prefabricated by application of the present invention, just as it is used for production of the flat commutator shown in FIG. 4,

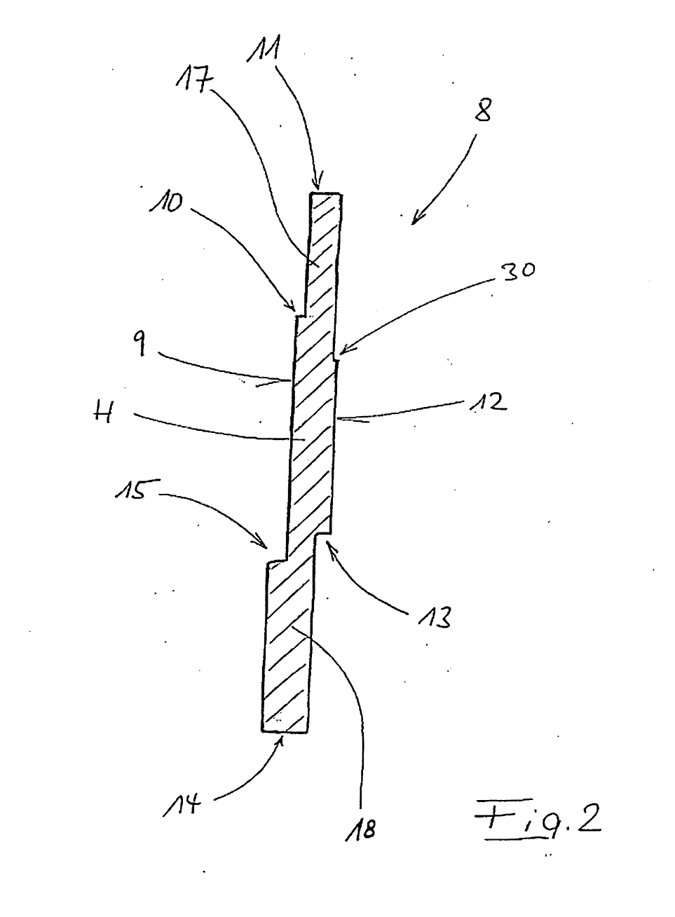

FIG. 2 shows a cross section through the strip having longitudinal tiers used to produce the conductor blank shown in FIG. 1,

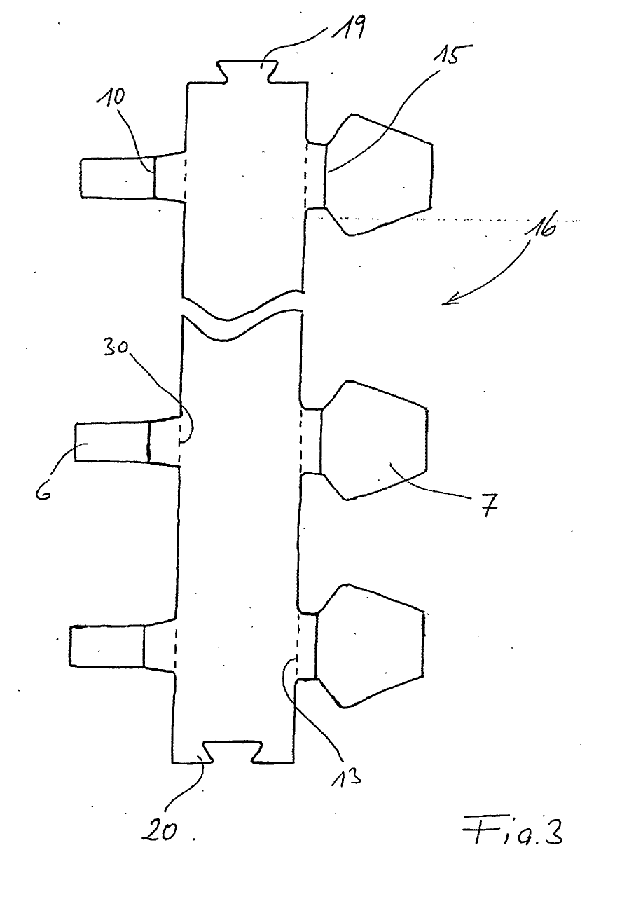

FIG. 3 shows a side view of the subsequent radial inside of the strip portion used to produce the conductor blank shown in FIG. 1, after the peripheral portions have been punched out, and

FIG. 4 shows an axial section of a flat commutator produced by application of the present invention.

Annularly closed conductor blank 1 illustrated in FIG. 1 comprises eight conductor segments 3 disposed uniformly around axis 2 and eight bridging parts 4, each of which joins two adjacent conductor segments 3 to one another. Each conductor segment has on one side a terminal region 5, which is aligned substantially axially, with a terminal hook 6, which is also aligned substantially axially, and on the other side a contact tab 7, which is aligned substantially radially inwardly. Bridging parts 4 jut radially outward in corrugated form beyond terminal regions 5 of conductor segments 3. Their wall thickness D₁ corresponds to the wall thickness D₂ of terminal regions 5 of conductor segments 3. These undulations stand out sufficiently far that the maximum distance of their inside wall from axis 2 is larger than the distance of the outside wall of terminal regions 5 from axis 2.

The conductor blank was obtained by a series of single forming steps from a metal strip 8 having longitudinal tiers in the form of the cross section shown in FIG. 2. On its one, first side 9, which represents the subsequent radial inside face, strip 8 has a first tier 10, which forms an enlargement of the material thickness compared with first periphery 11 of strip 8 adjacent to this tier. On its second side 12, which is opposite first side 9 and which forms the subsequent radial outside face, strip 8 has a second tier 13, which in turn forms an enlargement of the material thickness compared with its adjacent second periphery 14 of strip 8. First tier 10 and second tier 13 maintain a distance A from one another. The region of strip 8 lying between first tier 10 and second tier 13 forms its main portion H. The region of strip 8 located between first periphery 11 and first tier 10 forms its first peripheral portion 17. And the region of strip 8 located between second periphery 14 and second tier 13 forms its second peripheral portion 18.

Furthermore, strip 8 has a third tier 15 in second peripheral portion 18 on first side 9. At third tier 15, the material thickness increases toward second periphery 14.

To produce conductor blank 1, a portion 16 is first punched out, in a first working step, from a stock of the metal strip profiled in the form of longitudinal tiers (FIG. 3). At the same time, there are also punched out terminal hooks 6 in first peripheral portion 17, contact tabs 7 in second peripheral portion 18 and partly in main portion H, and the end regions with two mutually corresponding engagement portions 19 and 20 of a dovetail lock 21. Strip portion 16 is then rolled to form a closed annular structure, thus closing lock 21 that secures the butt joint. In a further working step, the undulation is introduced in annularly closed strip portion 16 by pushing conductor segments 3 radially inward in an appropriate die by corresponding radial plungers, while a profiled internal die braces bridging parts 4 radially from the inside. Contact tabs 7 are then bent inward toward axis 2 in two working tiers. Next the contact regions are profiled by axial shearing in mutually corresponding upper and lower dies, before anchor parts 22 are finally produced by a slitting step at the radial inside faces of terminal regions 5 of conductor segments 3.

Conductor blank 1 produced in this way is further processed to produce a flat commutator 23 with carbon brush running surfaces 24 in a method that is essentially known (see German Patent 19956844 A1). For this purpose, an annular carbon disk is joined together with conductor blank 1 to obtain a composite part, while establishing electrically conductive connections between contact tabs 7 of conductor segments 3 and the annular carbon disk. The composite part is then loaded into an open injection-molding die. The injection-molding die is closed. In the process, a first partial die bears on a first sealing face formed by first tier 10, side faces 25 of conical foot portions 26 of terminal hooks 6 and associated end faces 27 of bridging parts 4; and a second partial die bears on a second sealing face formed by second tier 13 and the associated end faces of bridging parts 4. Support member 28 is then formed by injecting plasticized molding compound into the injection-molding die. After the molding compound has cured, the injection-molding die is opened and the commutator blank formed in this way is removed from the injection-molding die. Bridging parts 4 are then removed by turning them off on the lathe, and the annular carbon disk is divided into individual carbon segments 29 by cuts. In view of the fact that the method used in this respect is adequately known from the prior art, detailed explanations are not necessary. However, it must still be pointed out that strip 8, in order to facilitate the turning off of bridging parts 4 as described in the foregoing, is provided on its second side 12, in the region of main portion H, with a fourth tier 30, at which the material thickness decreases in the direction of first periphery 11.

1. A method for production of a flat commutator (23), which is provided with a support member (28) made from a molding compound, a plurality of conductor segments (3) anchored in the support member and disposed uniformly around an axis (2), and an equally large number of carbon segments (29) connected in electrically conductive manner thereto and defining the brush running surfaces (24), with the following steps:
providing an annularly closed conductor blank (1) with conductor segments (3) and with bridging parts (4) connecting each two adjacent conductor segments with one another, the conductor segments having terminal regions (5) that are aligned substantially axially, each with a terminal hook (6) and contact tabs (7) that are aligned substantially radially;
providing an annular carbon disk;
joining the annular carbon disk and the conductor blank (1) together as a composite part while establishing electrically conductive connections between the contact tabs (7) of the conductor segments (3) and the annular carbon disk;
loading the composite part into an open injection-molding die;
closing the injection-molding die;
molding the support member (28) by injecting plasticized molding compound into the injection-molding die;
removing the commutator blank from the injection-molding die;
dividing the annular carbon disk into individual carbon segments (29) and removing or severing the bridging parts (4);
wherein the following prefabrication of the conductor blank is carried out:
provision of a metal strip (8) having longitudinal tiers, which strip is bounded by a first periphery (11) and a second periphery (14) parallel thereto, wherein the strip has a main portion (H), which is bounded by a first tier (10) disposed on a first side (9) of the strip adjacent to the first periphery and by a second tier (13) disposed on the other, second side (12) of the strip adjacent to the second periphery, a first peripheral portion (17) disposed between the first periphery and the first tier and a second peripheral portion (18) disposed between the second periphery and the second tier, and the material thickness of the strip at each of the first and second tiers decreases from the main portion to the corresponding peripheral portion, and wherein the strip is further provided on its first side (9) in the region of the second peripheral portion (18) with a third tier (15), at which the material thickness increases in the direction of the second periphery;
cutting to length of a portion (16) of the metal strip (8) and punching of the two peripheral portions (17, 18) out of the strip to form the terminal hooks (6) in the first peripheral portion (17) and the contact tabs (7) in the second peripheral portion (18);
rolling of the strip portion (16) to form a closed annular structure and introduction of undulation in the main portion with undulations jutting out in the region of the bridging parts (4), wherein the annular structure in the region of the undulations has substantially the same wall thickness (D1) as between the undulations;
bending of the contact tabs (7) inward toward the axis (2);
profiling of the contact tabs (7) on both axial end faces by a shearing process in axial direction.

2. A method according to claim 1,
characterized in that
a portion (16) of the metal strip (8) is cut to length and at the same time the two peripheral portions (17, 18) of the strip are punched out.

3. A method according to claim 1,
characterized in that
a portion (16) of the metal strip (8) is first cut to length and then the two peripheral portions (17, 18) of the strip are punched out.

4. A method according to claim 1,
characterized in that
a portion (16) of the metal strip (8) is cut to length after the two peripheral portions (17, 18) of the strip have been punched out.

5. A method according to one of claim 1,
characterized in that
the strip portion (16) is first rolled and then the undulation is introduced.

6. A method according to one of claim 1,
characterized in that
the strip portion (16) is rolled after the undulation has been introduced.

7. A method according to one of claim 1,
characterized in that
the strip portion (16) is rolled in a single working step in order to form a closed annular structure, and at the same time the undulation is introduced.

8. A method according to one of claim 1,
characterized in that,
during rolling of the strip portion (16), two mutually corresponding engagement portions (19, 20) provided at the ends of main portion (H) for a dovetail lock (21) are joined to one another.

9. A method according to one of claim 1,
characterized in that
bending of the contact tabs (7) inward toward the axis (2) takes place in two steps.

10. A method according to one of claim 1,
characterized in that
anchor parts (22) are produced on the radial inside faces of the terminal regions (5) of the conductor segments by a slitting step.

11. A method according to one of claim 1,
characterized in that
the punched-out part of the contact tabs (7) extends exclusively in the second peripheral portion (18).

12. A method according to one of claim 1,
characterized in that
the punched-out part of the terminal hooks (6) extends into the main portion (H).

13. A method according to claim 12,
characterized in that
the punched-out part of the terminal hooks (6) is bounded in the main portion (H) by conical edges.

14. A method according to claim 1,
characterized in that
the bridging parts (4) are completely removed in a single operation by turning them off on the lathe.

15. An annularly closed conductor blank (1) for use in a method for production of a flat commutator (23), comprising a plurality of conductor segments (3) disposed uniformly around an axis (2) together with bridging parts (4) connecting each two adjacent conductor segments with one another, the conductor segments having terminal regions (5) that are aligned substantially axially, each with a terminal hook (6) and contact tabs (7) that are aligned substantially radially inwardly, the conductor blank (1) being produced from a metal strip having longitudinal tiers (8) and a butt joint being present in the region of one of the bridging parts (4), while the bridging parts are made in the form of undulations, which jut outward relative to the conductor segments (3) and have substantially the same wall thickness (D2) as the conductor segments.

16. A conductor blank according to claim 15,
characterized in that
a dovetail lock (21) with two mutually corresponding engagement portions (19, 20) disposed at the ends of the strip (8) and fitting into one another is provided in the region of the butt joint.

17. A conductor blank according to claim 15,
characterized in that
its surface is silvered or tinned at least in the regions of the contact tabs (7) scheduled for contact with the carbon segments (29).
